(19) United States
(12) Patent Application Publication
(10) Pub. No.: US 2013/0196717 A1
(43) Pub. Date: Aug. 1, 2013

(54) Information Processing Method, and Terminal Device

(71) Applicant: Huawei Technologies Co., Ltd., Shenzhen (CN)

(72) Inventor: Leilei Cao, Shenzhen (CN)

(73) Assignee: Huawei Technologies Co., Ltd., Shenzhen (CN)

(21) Appl. No.: 13/727,792

(22) Filed: Dec. 27, 2012

Related U.S. Application Data
(63) Continuation of application No. PCT/CN2012/070818, filed on Feb. 1, 2012.

(51) Int. Cl. H04W 88/02

(52) U.S. Cl. CPC H04W 88/02
USPC 455/566

(57) ABSTRACT

Embodiments of the present invention provide an information processing method and a terminal device. The terminal device in the embodiments of the present invention displays generated contact identifiers on a screen of the terminal device in the form of matrix arrangement and further obtains a target contact identifier selected by a user of the terminal device from the displayed contact identifiers. In this way, the terminal device can perform, according to the target contact identifier, a service operation that is corresponding to the target contact identifier, which can avoid a problem that in the prior art, the number of contact identifiers displayed on each page is limited because the terminal device adopts the form of a single column to display a contact identifier of each contact on the screen, thereby effectively improving display efficiency and a screen utilization rate.

This application is a continuation application of International Application No. PCT/CN2012/070818, filed Feb. 1, 2012, entitled “INFORMATION PROCESSING METHOD, AND TERMINAL DEVICE”, which is incorporated herein by reference in its entirety.

### TECHNICAL FIELD

The present invention relates to information processing technologies, and in particular, to an information processing method and a terminal device.

### BACKGROUND

With the increase of a storage capacity of a terminal device, more and more user-related information is stored in the terminal device. The terminal device generally displays a contact identifier of each contact in the form of a single column, and one contact identifier occupies a row on a screen of the terminal device.

The terminal device displays a contact identifier of each contact in the form of a single column on the screen, and therefore the number of contact identifiers displayed on each page is limited. In this way, a user of the terminal device needs to turn to a next page continuously to find a specific contact identifier. As a result, display efficiency and a screen utilization rate are reduced.

### SUMMARY OF THE INVENTION

The present invention provides an information processing method and a terminal device to improve display efficiency of a terminal device.

In an aspect, an information processing method is provided, and includes generating, by a terminal device, contact identifiers, and displaying the contact identifiers on a screen of the terminal device in the form of matrix arrangement, obtaining, by the terminal device, a target contact identifier selected by a user of the terminal device from the displayed contact identifiers, and performing, by the terminal device, according to the target contact identifier, a service operation that is corresponding to the target contact identifier.

In another aspect, a terminal device is provided, and includes a displaying unit, configured to generate contact identifiers, and display the contact identifiers on a screen of the terminal device in the form of matrix arrangement, an obtaining unit, configured to obtain a target contact identifier selected by a user of the terminal device from the contact identifiers that are displayed by the displaying unit, and a performing unit, configured to perform, according to the target contact identifier, a service operation that is corresponding to the target contact identifier.

It can be known from the foregoing technical solutions that, the terminal device in the embodiments of the present invention displays the generated contact identifiers on the screen of the terminal device in the form of matrix arrangement and further obtains the target contact identifier selected by the user of the terminal device from the displayed contact identifiers. In this way, the terminal device can perform, according to the target contact identifier, the service operation that is corresponding to the target contact identifier, which can avoid a problem that in the prior art, the number of contact identifiers displayed on each page is limited because the terminal device adopts the form of a single column to display a contact identifier of each contact on the screen, thereby effectively improving display efficiency and a screen utilization rate.

### BRIEF DESCRIPTION OF THE DRAWINGS

To describe the technical solutions in the embodiments of the present invention or in the prior art more clearly, the accompanying drawings required for describing the embodiments or the prior art are briefly introduced in the following. Apparently, the accompanying drawings in the following description are some embodiments of the present invention, and persons of ordinary skill in the art may also derive other accompanying drawings from these accompanying drawings without creative efforts.

FIG. 1 is a schematic flowchart of an information processing method according to an embodiment of the present invention;

FIG. 2 is a schematic diagram of displaying contact identifiers on a screen of a terminal device in the form of matrix arrangement according to the embodiment corresponding to FIG. 1;

FIG. 3 is a schematic diagram of a manner for a terminal device to display, in the neighborhood of a target contact identifier, a service option corresponding to the target contact identifier according to the embodiment corresponding to FIG. 1;

FIG. 4 is a schematic diagram of another manner for a terminal device to display, in the neighborhood of a target contact identifier, a service option corresponding to the target contact identifier according to the embodiment corresponding to FIG. 1;

FIG. 5 is a schematic diagram of another manner for a terminal device to display, in the neighborhood of a target contact identifier, a service option corresponding to the target contact identifier according to the embodiment corresponding to FIG. 1;

FIG. 6 is a schematic structural diagram of a terminal device according to another embodiment of the present invention;

FIG. 7 is a schematic structural diagram of a terminal device according to another embodiment of the present invention; and

FIG. 8 is a schematic structural diagram of a terminal device according to another embodiment of the present invention.

### DETAILED DESCRIPTION OF ILLUSTRATIVE EMBODIMENTS

To make the objectives, technical solutions, and advantages of the embodiments of the present invention more clearly, the technical solutions in the embodiments of the present invention are clearly and completely described with reference to the accompanying drawings in the embodiments of the present invention. Apparently, the embodiments to be described are only a part of rather than all of the embodiments of the present invention. Based on the embodiments in the present invention, all other embodiments that are obtained by persons of ordinary skill in the art without creative efforts fall within the protection scope of the present invention.

It should be noted that a terminal device involved in the embodiments of the present invention includes, but is not limited to: a mobile phone, a personal digital assistant (Personal Digital Assistant, referred to as PDA), a radio handheld device, a radio netbook, a laptop, an MP3 player, or an MP4 player.

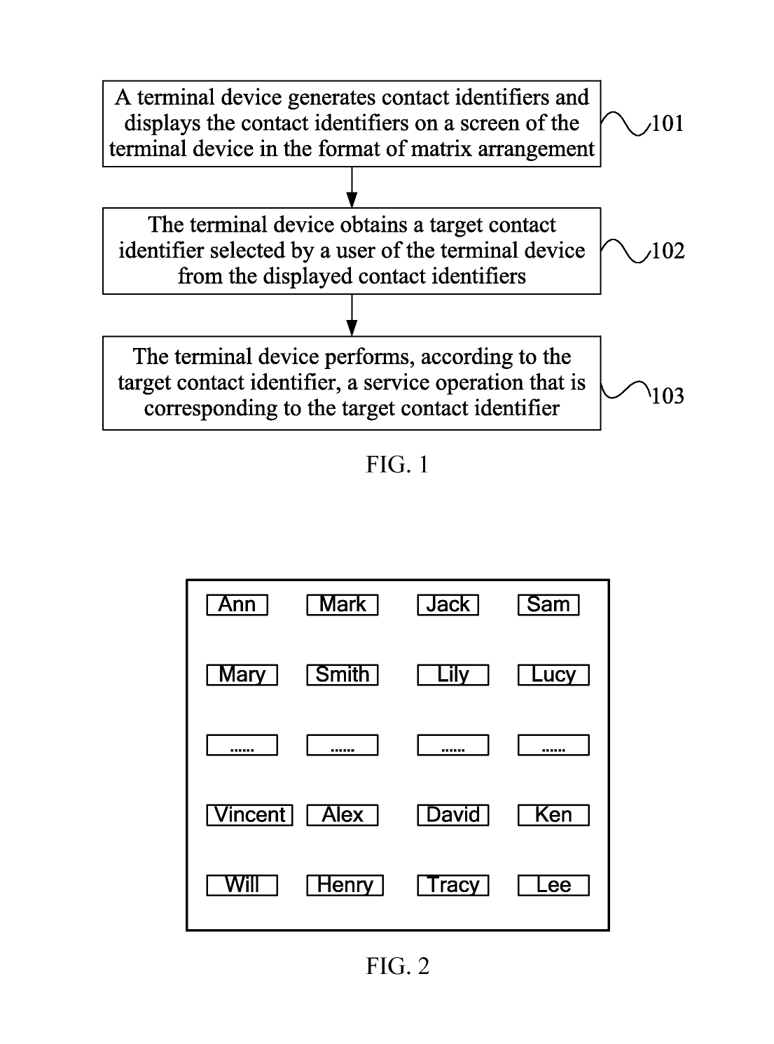

FIG. 1 is a schematic flowchart of an information processing method according to an embodiment of the present invention. As shown in FIG. 1, the information processing method in this embodiment may include:

101: A terminal device generates contact identifiers and displays the contact identifiers on a screen of the terminal device in the form of matrix arrangement.

As shown in FIG. 2, it can be seen that, the terminal device displays the generated contact identifiers on the screen of the terminal device in the form of matrix arrangement, which can avoid a problem that a user of the terminal device needs to turn to a next page continuously to find a specific contact identifier because the terminal device adopts the form of a single column to display contact identifiers on the screen, thereby effectively improving display efficiency and a screen utilization rate.

102: The terminal device obtains a target contact identifier selected by a user of the terminal device from the displayed contact identifiers.

103: The terminal device performs, according to the target contact identifier, a service operation that is corresponding to the target contact identifier.

In an optical implementation manner of the present invention, the terminal device may further display, in the neighborhood of the target contact identifier, a service option that is corresponding to the target contact identifier; and then the terminal device receives service selection input that is specific to the service option, and from the user of the terminal device, and performs, according to a selected service option, a service operation that is corresponding to the selected service option.

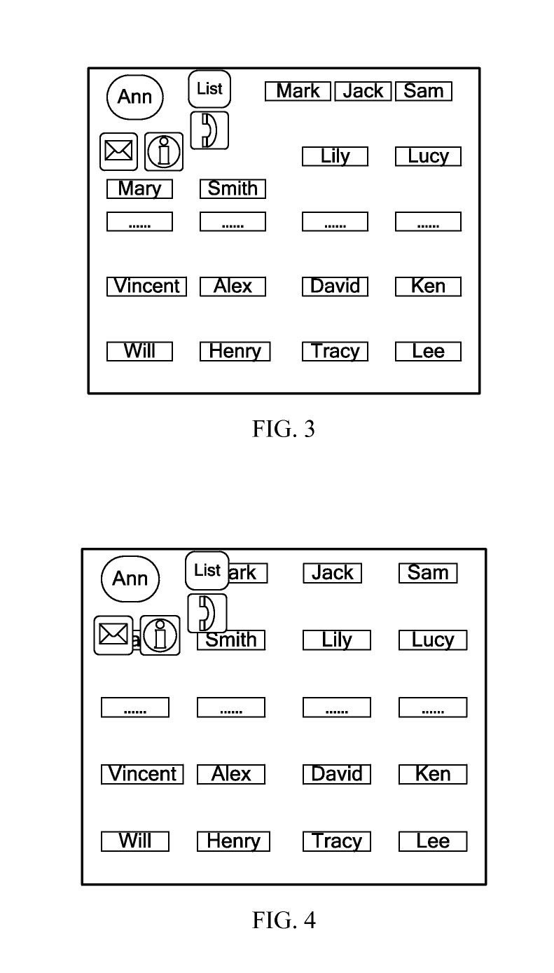

For example, the terminal device moves an unselected contact identifier in the neighborhood of the target contact identifier on the screen, and displays the service option between the target contact identifier and the moved and unselected contact identifier, where the service option is corresponding to the target contact identifier, as shown in FIG. 3.

For example, the terminal device displays the service option corresponding to the target contact identifier above the unselected contact identifier in the neighborhood of the target contact identifier, as shown in FIG. 4.

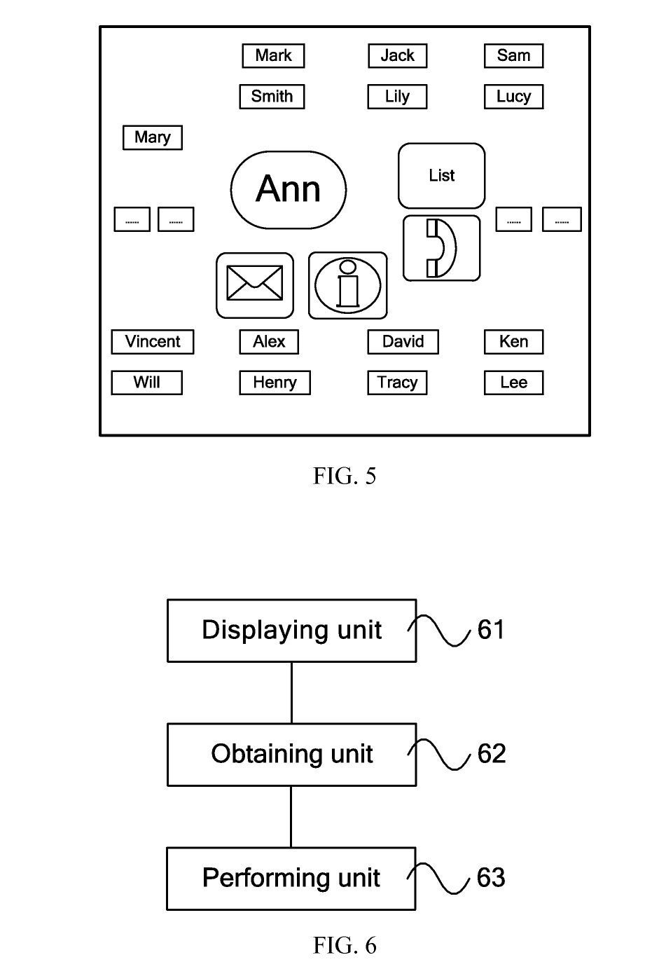

For example, the terminal device moves the target contact identifier to a specified position on the screen, zooms in the target contact identifier and the service option that is corresponding to the target contact identifier, and zooms out another unselected contact identifier, as shown in FIG. 5.

The service option may include, but is not limited to at least one of the following items: a call, a short message, a multimedia message, an email, and an e-name card. FIG. 3, FIG. 4, and FIG. 5 shows contact information [symbol] , a call [symbol] , a short message [symbol] , and an email [symbol] .

In the prior art, when the terminal device needs to perform a service operation on stored service information (for example, a telephone number, a communication address, or an email address), for example, dialing a telephone number in the stored service information or sending the stored service information to another terminal device, the terminal device can match only a corresponding service option from an address book, displays the service option on a single interface by adopting a page switching operation, and then performs a corresponding service operation on the service option according to selection of a user. However, because the page switching operation adopted by the terminal device lasts for a longer time, time for displaying the service option is longer. As a result, information processing efficiency is reduced. By adopting the technical solution in this embodiment of the present invention, the terminal device displays the service option on the current page, where the service option is corresponding to the selected target contact identifier, so that the terminal device can display the service option immediately, which can avoid a problem that in the prior art, time for displaying the service option is longer because the page switching operation adopted by the terminal device lasts for a longer time, thereby improving information processing efficiency.

In an optional implementation manner of the present invention, the terminal device may be a touch-screen terminal, and correspondingly, the screen may be a touch-screen. Further, the terminal device may further receives a move instruction for moving a position of a target contact identifier, where the move instruction is triggered after a user of the terminal device performs a drag operation on the target contact identifier on the touch screen; and then the terminal device may move the target contact identifier to a position specified by the move instruction, which can avoid a problem that in the prior art, searching for a contact identifier lasts for a longer time because contact identifiers are sequenced in an order of Pinyin or a first letter of the Pinyin of their family names. Therefore, the information processing efficiency is further improved.

In this embodiment, the terminal device displays the generated contact identifiers on the screen of the terminal device in the form of matrix arrangement and further obtains the target contact identifier selected by the user of the terminal device from the generated contact identifiers, so that the terminal device can perform, according to the target contact identifier, the service operation that is corresponding to the target contact identifier, which can avoid a problem that in the prior art, the number of contact identifiers displayed on each page is limited because the terminal device adopts the form of a single column to display a contact identifier of each contact on the screen, thereby effectively improving display efficiency and a screen utilization rate.

It should be noted that, to facilitate description, the foregoing method embodiments are described as a series of action combinations. However, those skilled in the art should know that the present invention is not limited to a sequence of described actions because some steps may be in another sequence or be performed at the same time according to the present invention. In addition, those skilled in the art should also know that the embodiments described in the specification are all exemplary embodiments, and involved actions and modules are not definitely needed in the present invention.

In the foregoing embodiments, a description of each embodiment has a focus. For a part that is not described in detail in a certain embodiment, reference may be made to a related description of another embodiment.

FIG. 6 is a schematic structural diagram of a terminal device according to another embodiment of the present invention. As shown in FIG. 6, the terminal device in this embodiment may include a displaying unit 61, an obtaining unit 62, and a performing unit 63.

The displaying unit 61 is configured to generate contact identifiers, and display the contact identifiers on a screen of the terminal device in the form of matrix arrangement; the obtaining unit 62 is configured to obtain a target contact identifier selected by a user of the terminal device from the contact identifiers that are displayed by the displaying unit 61; and the performing unit 63 is configured to perform, according to the target contact identifier obtained by the obtaining unit 62, a service operation that is corresponding to the target contact identifier.

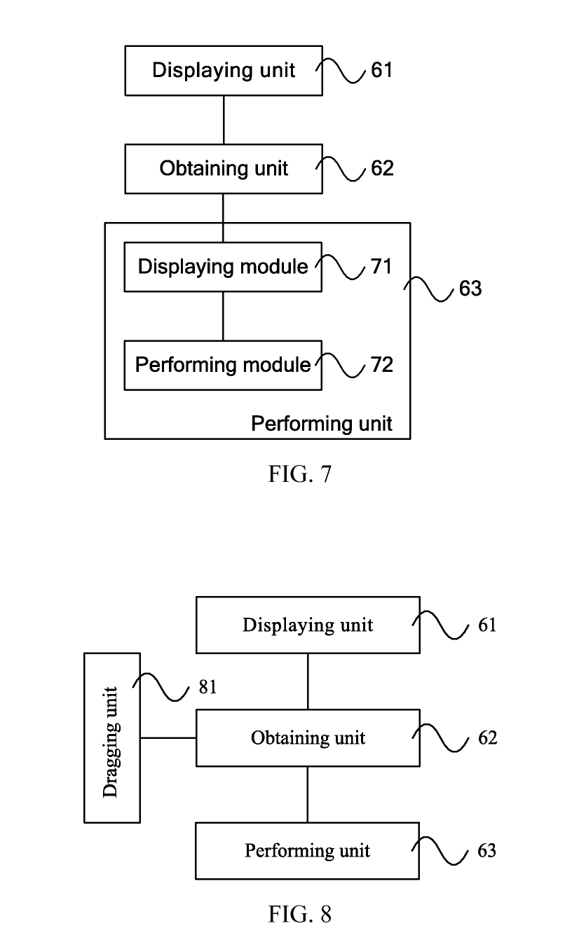

In an optional implementation manner of the present invention, as shown in FIG. 7, a performing unit 63 may further include a displaying module 71, configured to display, in the neighborhood of the target contact identifier, a service option that is corresponding to the target contact identifier, and a performing module 72, configured to receive service selection input that is specific to the service option and from the user of the terminal device, and perform, according to a selected service option, a service operation that is corresponding to the selected service option.

For example, the displaying module 71 may move an unselected contact identifier in the neighborhood of the selected target contact identifier on the screen, and display the service option between the target contact identifier and the moved and unselected contact identifier, where the service option is corresponding to the target contact identifier, as shown in FIG. 3.

For example, the displaying module 71 may display the service option corresponding to the target contact identifier above the unselected contact identifier in the neighborhood of the target contact identifier, as shown in FIG. 4.

For example, the displaying module 71 may move the target contact identifier to a specified position on the screen, zoom in the target contact identifier and the service option that is corresponding to the target contact identifier, and zoom out another unselected contact identifier, as shown in FIG. 5.

The service option may include, but is not limited to at least one of the following items: a call, a short message, a multimedia message, an email, and an e-name card. FIG. 3, FIG. 4, and FIG. 5 shows contact information [symbol] , a call [symbol] , a short message [symbol] , and an email [symbol] .

In the prior art, when the terminal device needs to perform a service operation on stored service information (for example, a telephone number, a communication address, or an email address), for example, dialing a telephone number in the stored service information or sending the stored service information to another terminal device, the terminal device can match only a corresponding service option from an address book, displays the service option on a single interface by adopting a page switching operation, and then performs a corresponding service operation on the service option according to selection of a user. However, because the page switching operation adopted by the terminal device lasts for a longer time, time for displaying the service option is longer. As a result, information processing efficiency is reduced. By adopting the technical solution in this embodiment of the present invention, the displaying module displays the service option on the current page, where the service option is corresponding to the selected target contact identifier, so that the terminal device can display the service option immediately, which can avoid a problem that in the prior art, time for displaying the service option is longer because the page switching operation adopted by the terminal device lasts for a longer time, thereby improving the information processing efficiency.

In an optional implementation manner of the present invention, as shown in FIG. 8, a terminal device provided in this embodiment of the present invention may be a touch-screen terminal, and correspondingly, the screen may be a touch-screen. Further, the terminal device may further include a dragging unit 81, configured to receive a move instruction for moving a position of the target contact identifier, where the move instruction is triggered after a user of the terminal device performs a drag operation on the target contact identifier on the touch screen; and move the target contact identifier to a position specified by the move instruction, which can avoid a problem that in the prior art, searching for a contact identifier lasts for a longer time because contact identifiers are sequenced in alphabetical order. In some embodiments, the contact identifiers are converted from Chinese characters to latin script (e.g., English or otherwise) in accordance with a translation technique (such as Pinyin) prior to being sequenced in alphabetical order. The alphabetical order may be based on a first letter of the surname (e.g., the first letter of the family name after Pinyin conversion). Therefore, the information processing efficiency is further improved.

In this embodiment, the terminal device displays, through the displaying unit, the generated contact identifiers on the screen of the terminal device in the form of matrix arrangement, and the obtaining unit further obtains the target contact identifier selected by the user of the terminal device from the contact identifiers that are displayed by the displaying unit, so that the performing unit can perform, according to the target contact identifier, the service operation that is corresponding to the target contact identifier, which can avoid a problem that in the prior art, the number of contact identifiers displayed on each page is limited because the terminal device adopts the form of a single column to display a contact identifier of each contact on the screen, thereby effectively improving display efficiency and a screen utilization rate.

Those skilled in the art may clearly understand that for convenience and simplicity of description, for working processes of the system, apparatus, and units in the foregoing description, reference may be made to corresponding processes in the foregoing method embodiments, which are not described here again.

It should be understood that the system, apparatus, and method that ere disclosed in the several embodiments provided in this application may be implemented in another manner. For example, the foregoing described apparatus embodiment is merely exemplary. For example, the units are divided only in terms of logic functions, which may be actually divided in another manner during implementation. For example, multiple units or components may be combined or may be integrated into another system, or some features may be ignored or may not be executed. In addition, the illustrated or described inter-coupling, direct coupling, or communicatively connection may be implemented through some interfaces, and the direct coupling or communicatively connection between apparatuses or units may be in the form of electronic or mechanical, or in another form.

The units described as separate components may be or may not be physically separate. A component used as a displaying unit may be or may not be a physical unit, namely, the component may be either located at a place or may be distributed on multiple network units. A part of or all of the units may be selected as required so as to achieve the objective of the solution in this embodiment.

In addition, various function units in each embodiment of the present invention may be integrated in a processing unit, and may also be physical independent entities of various units; or two or more than two function units may also be integrated into one unit. The integrated unit may not only be implemented in the form of hardware, but also implemented in the form of hardware plus a software function unit.

The integrated unit that is implemented in the form of a software function unit may be stored in a computer readable storage medium. The software function unit is stored in a storage medium, including several instructions that are used to enable a computer device (for example, may be a personal computer, a server, or a network device) to perform a part of steps in the method in each embodiment of the present invention. The storage medium includes various medium capable of storing program codes, such as a U disk, a movable hard disk, a read only memory (Read-Only Memory, referred to as ROM), a random access memory (Random Access Memory, referred to as RAM), a magnetic disk, or an optical disk.

Finally, it should be noted that the foregoing embodiments are merely used for describing the technical solutions in the present invention, but are not intended to limit the present invention. Although the present invention is described in detail with reference to the foregoing embodiments, those skilled in the art should understand that modifications may still be made to the technical solution described in each foregoing embodiment, or equivalent replacements may be made to some technical features in the technical solution, however, these modifications and replacements do not make the essence of the corresponding technical solution depart from the spirit and scope of the technical solution in each embodiment of the present invention.

What is claimed is:

1. An information processing method, comprising:
generating, by a terminal device, contact identifiers;
displaying, by the terminal device, the contact identifiers on a screen of the terminal device in the form of matrix arrangement;
obtaining, by the terminal device, a target contact identifier selected by a user of the terminal device from the displayed contact identifiers; and
performing, by the terminal device, a service operation in accordance with the target contact identifier, wherein the service operation corresponds to the target contact identifier.

2. The method according to claim 1, wherein the performing the service operation in accordance with the target contact identifier comprises:
displaying, by the terminal device, a service option in the neighborhood of the target contact identifier, wherein the service option corresponds to the target contact identifier;
receiving, by the terminal device, service selection input from the user of the terminal device, wherein the service selection input is specific to the service option; and
performing a service operation in accordance with a selected service option, wherein the service operation corresponds to the selected service option.

3. The method according to claim 2, wherein displaying the service option in the neighborhood of the target contact identifier comprises:
moving, by the terminal device, an unselected contact identifier in the neighborhood of the target contact identifier on the screen; and
displaying the service option between the target contact identifier and the moved and unselected contact identifier, wherein the service option corresponds to the target contact identifier.

4. The method according to claim 2, wherein displaying the service option in the neighborhood of the target contact identifier comprises:
displaying, by the terminal device, the service option corresponding to the target contact identifier above the unselected contact identifier in the neighborhood of the target contact identifier.

5. The method according to claim 2, wherein displaying the service option in the neighborhood of the target contact identifier comprises:
moving, by the terminal device, the target contact identifier to a specified position on the screen, zooming in the target contact identifier and the service option that is corresponding to the target contact identifier, and zooming out another unselected contact identifier.

6. The method according to claim 2, wherein the service option comprises at least one of the following items: contact information, a call, a short message, a multimedia message, an email, and an e-name card.

7. The method according to claim 1, wherein the terminal device is a touch-screen terminal and the screen is a touch-screen; and the method further comprises:
receiving, by the terminal device, a move instruction for moving a position of the target contact identifier, wherein the move instruction is triggered after the user of the terminal device performs a drag operation on the target contact identifier on the touch screen; and
moving, by the terminal device, the target contact identifier to a position specified by the move instruction.

8. A terminal device, comprising:
a displaying unit, configured to generate contact identifiers, and to display the contact identifiers on a screen of the terminal device in the form of matrix arrangement;
an obtaining unit, configured to obtain a target contact identifier selected by a user of the terminal device from the contact identifiers that are displayed by the displaying unit; and
a performing unit, configured to perform a service operation in accordance with the target contact identifier, wherein the service operation corresponds to the target contact identifier.

9. The terminal device according to claim 8, wherein the performing unit comprises:
a displaying module, configured to display a service option in the neighborhood of the target contact identifier, wherein the service option corresponds to the target contact identifier; and
a performing module, configured to receive service selection input from the user of the terminal device, and to perform a service operation according to a selected service option, wherein the service selection input is specific to the service option, and wherein the service operation corresponds to the selected service option.

10. The terminal device according to claim 9, wherein the displaying module is configured to:
move an unselected contact identifier in the neighborhood of the target contact identifier on the screen, and display the service option between the target contact identifier and the moved unselected contact identifier, wherein the service option is corresponding to the target contact identifier.

11. The terminal device according to claim 9, wherein the displaying module is configured to:
display the service option corresponding to the target contact identifier above the unselected contact identifier in the neighborhood of the target contact identifier.

12. The terminal device according to claim 9, wherein the displaying module is configured to:
move the target contact identifier to a specified position on the screen, to zoom in on the target contact identifier and the service option that is corresponding to the target contact identifier, and to zoom out to another unselected contact identifier.

13. The terminal device according to claim 9, wherein the service option comprises at least one of the following items: a contact information, a call, a short message, a multimedia message, an email, and an e-name card.

14. The terminal device according to claim 8, wherein the terminal device is a touch-screen terminal and the screen is a touch-screen, and
wherein the terminal device further comprises a dragging unit, configured to receive a move instruction for moving a position of the target contact identifier, and to move the target contact identifier to a position specified by the move instruction, wherein the move instruction is triggered after the user of the terminal device performs a drag operation on the target contact identifier on the touch screen.
